(19) United States
(12) Patent Application Publication
(10) Pub. No.: US 2003/0043274 A1
(43) Pub. Date: Mar. 6, 2003

(54) Method for semiautomated digital photo editing

(76) Inventor: Ronald Gentile, Los Altos, CA (US)

Correspondence Address: COUDERT BROTHERS, Suite 3300, Four Embarcadero Center, San Francisco, CA, 94111, US

(21) Appl. No.: 09/877,460

(22) Filed: Jun. 7, 2001

(51) Int. Cl. H04N 9/47

(52) U.S. Cl. 348/207.99; 348/96

(57) ABSTRACT

The present invention provides for a method for semiautomated digital photo editing including the steps of: receiving a digital proxy photo, the proxy photo being generated from a customer's original photo, and digitally processing the proxy photo using an assembly line of at least one Operator Station, wherein at least one of the Operator Stations has a human operator. Digital processing returns a photo-editing script that may be used to edit the original photo.

### FIELD OF THE INVENTION

This invention relates to a method of processing a photo, and more specifically to a semiautomated method of editing a photo that is in digital form.

### BACKGROUND OF THE INVENTION

The number of consumer photos in digital form (“digital photo” or “digital image”) is increasing rapidly due to a variety of factors including the increase in unit sales, decrease in price and increase in the quality of digital cameras and scanners, and increase in the number of film digitization services. One of the promises of working with digital photos is the ability to edit the photo to the end user's satisfaction. Such edits include cropping, exposure and color adjustments, and red-eye removal.

For many years, software companies have provided consumer shrink-wrap, photo-editing software. In addition, most digital cameras and scanners are sold with such software bundled. There are also on-line photo-finishing sites that utilize photo editing tools that work in web browsers. Despite the widespread availability of such software, the majority of end users don't successfully use the software to edit their digital photos due to difficulty in using the software, time considerations, and lack of digital imaging and photography skills. Moreover, there does not exist an algorithm and corresponding piece of software that can take a digital photo, analyze it, and fix it to high-quality standards across a wide range of consumer photos because editing photos is a very subjective and complex process.

What is needed is a method for processing digital photos and returning high-quality edited versions for a nominal cost.

Corollary problems include the time required to transmit digital images, the speed of the editing process, and the memory required to store the image due to the large amount of data contained in each image. For example, when taken by a digital camera, a digital photo is stored in the camera's memory in the form of a number of bytes of data corresponding to the pixels in a digital photo. A digital photo's quality is determined by a grid of these pixels. Thus, the more pixels used to record a digital image, the better quality that image is and the more accurately it reflects the image recorded.

The digital image sensors in digital cameras continue to increase in pixel density. Today 3 megapixel cameras are typically at the upper end of the consumer market but 4 megapixel cameras are becoming more prevalent. A 3 megapixel camera generates an uncompressed file of about 9 megabytes of data. The factor of 3 comes from the three color components used to represent a color photo-red, green and blue.

Generally digital cameras offer the option of storing the captured photo in an uncompressed or compressed representation. Uncompressed is better quality, but fewer photos can be held on the camera's memory. Additionally, most digital cameras offer multiple compression settings (and resolution settings) for which to store the captured photo. In practice, the captured photo on a 3 megapixel camera might be compressed down to a range of 500K bytes to 1M byte of data which still represents a fairly large file to transmit.

What is needed is a digital photo-editing process that efficiently transmits any sized digital photo to a photo-processing facility, edits the photo and then efficiently transmits an edited photo back to the customer.

### SUMMARY OF THE INVENTION

The present invention is directed at addressing the above-mentioned shortcomings, disadvantages, and problems. The present invention provides for a method for semiautomated digital photo editing including the steps of: receiving a digital proxy photo, the proxy photo being generated from a customer's original photo, and digitally processing the proxy photo at a remote facility using an assembly line of at least one Operator Station, wherein at least one of the Operator Stations has a human operator. The digital processing including the steps of: (1) determining at least one edit task to be performed on the proxy photo; selecting one of the Operator Stations to perform the determined edit task and forwarding the proxy photo to the selected Operator Station; (3) performing at the selected Operator Station the edit task and generating edit results; (4) determining whether any additional edit tasks need to be performed on the proxy photo, and if so, updating the proxy photo to include the edit results generated in step (3), determining a next edit task to be performed on the updated proxy photo, selecting one of the Operator Stations to perform the next edit task, forwarding the updated proxy photo to the selected Operator Station, and repeating steps (3) and (4) until the proxy photo needs no additional edits; and (5) generating a photo-editing script from the edit results generated by the selected Operator Station.

In a preferred embodiment, the method for digital photo editing further includes the steps of: receiving in a Master Server a customer's original photo; generating in the Master Server a digital proxy photo, the proxy photo is forwarded by the Master Server to a Factory Server at a remote facility; the remote facility also including the assembly line of Operator Stations. After the Factory Server receives the proxy photo it performs the following digital processing steps: (1) determining at least one edit task to be performed on the proxy photo; (2) selecting an Operator Station to perform the edit task; and (3) forwarding the proxy photo to the selected Operator Station. The Factory Server also determines whether any additional edits are needed and if so: (1) updates the proxy photo; (2) determines a next edit task; (3) selects an Operator Station to perform the next edit task; and (4) forwards the updated proxy photo to the next selected Operator Station. Finally, the Factory Server generates the photo-editing script from the edit results received from each selected Operator Station and forwards the script to the Master Server. The Master Server uses the photo-editing script to generate an edited photo to send to the customer.

In other embodiments of the present invention, certain process steps can be varied to still achieve a high-quality digitally edited photo. For instance, in one embodiment instead of the Factory Server forwarding the proxy photo to each Operator Station, an Operator Station may forward the proxy photo to the next Operator Station in the sequence. In another embodiment, the customer generates the proxy photo, not the Master Server, and the customer receives back the photo-editing script instead of an edited photo. In another embodiment, there is a single server. In yet another embodiment multiple Master Servers and Factory Servers are provided, and in another embodiment multiple Factory Servers are provided, but no Master Servers. In a final embodiment, the output of each Operator Station is an edited original photo instead of a photo-editing script.

An objective and advantage of the present invention is to provide high quality digitally edited photos for a nominal cost through the use of a more efficient semiautomated digital photo editing process. A key advantage of the present invention is that it utilizes an efficient and cost effective assembly line of Operator Stations at a remote facility to edit digital photos according to the most effective order of edit tasks. Another advantage of the present invention is its use of available techniques to first compress the size of the digital images to be edited to minimize the bandwidth required to transmit those digital images to the remote facility and second to transmit a resulting photo-editing script back to the Master Server, rather than an edited photo. A further advantage of the present invention is that it minimizes the amount of time it takes to edit the digital images while at the remote facility.

### BRIEF DESCRIPTION OF THE DRAWINGS

The forgoing aspects and attendant advantages of the present invention will become more readily appreciated by reference to the following detailed description, when taken in conjunction with the accompanying drawings, wherein:

FIG. 1 is a flow diagram illustrating a digital photo editing process according to the present invention.

FIG. 2 is a block diagram of a digital photo editing system with a single Master Server and Factory Server that edits digital photos according to a preferred embodiment of the present invention.

FIG. 3 is a block diagram of a digital photo editing system with multiple Master Servers and Factory Servers.

FIG. 4 is a flow diagram illustrating the digital photo editing process steps performed by the system illustrated in FIG. 2 and performed according to the preferred embodiment of the present invention.

FIG. 5 is a block diagram illustrating the Remote Facility that performs the digital processing step according to another embodiment of the present invention, wherein each Operator Station determines the next edit task to be performed and then forwards the proxy photo to the next Operator Station for processing.

FIG. 6 is a flow diagram illustrating the digital photo editing process steps performed at the Remote Facility illustrated in FIG. 5.

FIG. 7 is a block diagram illustrating a Remote Facility that performs the digital processing step according to another embodiment of the present invention, wherein either the Factory Server or an Operator Station may forward the proxy photo to the next Operator Station.

FIG. 8 is a flow diagram illustrating the digital photo editing processing steps according to another embodiment of the present invention, wherein the customer generates the digital proxy photo.

FIG. 9 is a flow diagram illustrating the digital photo editing process steps according to another embodiment of the present invention, wherein the process edits a customer's original photo without generating a photo-editing script.

FIG. 10 is a block diagram illustrating a digital photo editing system with a single server that edits digital photos according to the present invention.

FIG. 11 is a block diagram illustrating a digital photo editing system with multiple remote facilities having a single server.

### DETAILED DESCRIPTION OF THE INVENTION

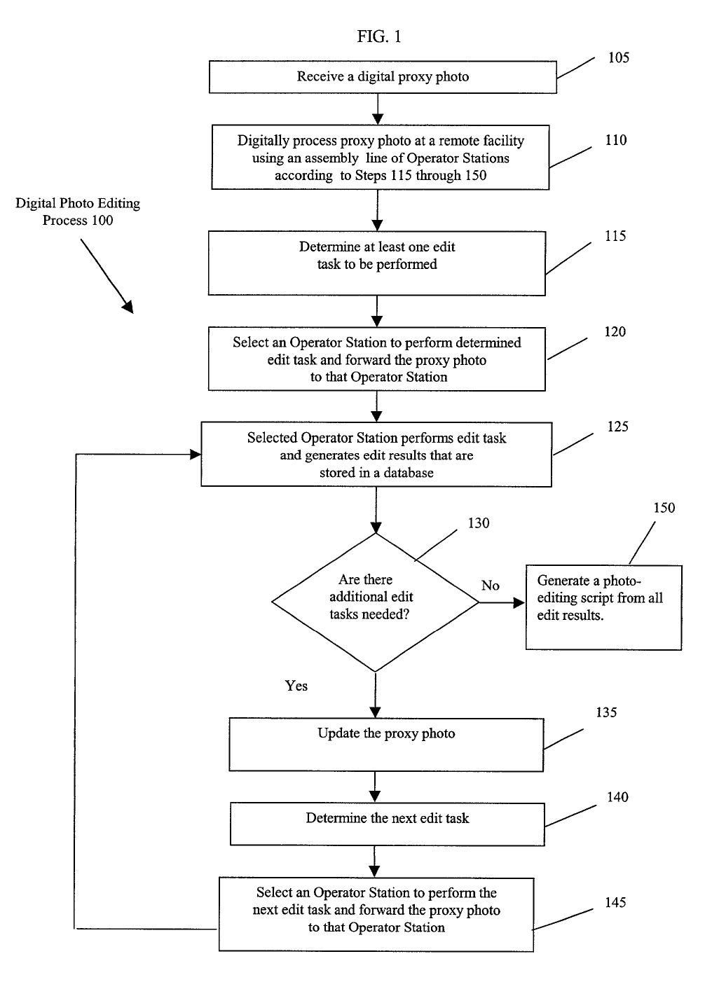

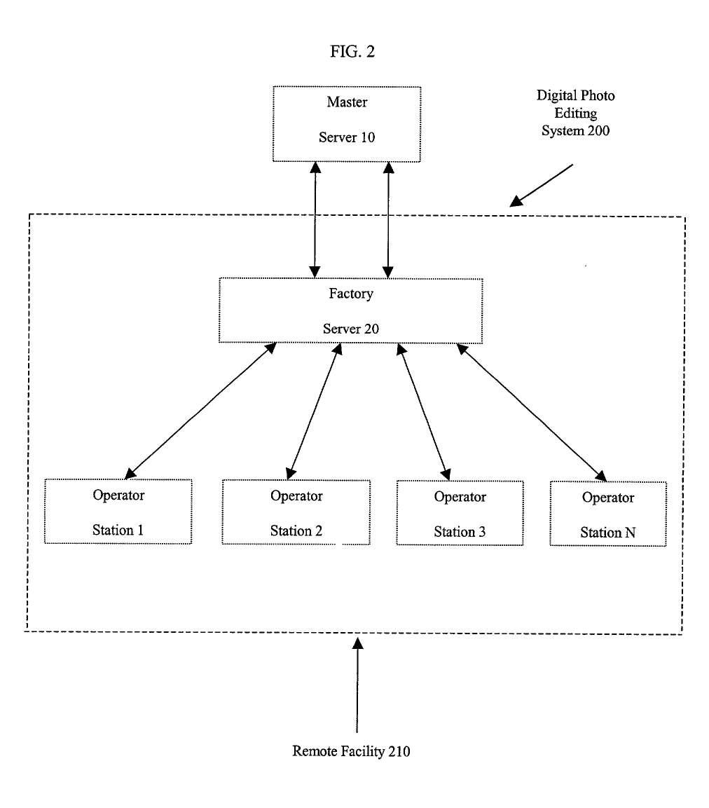

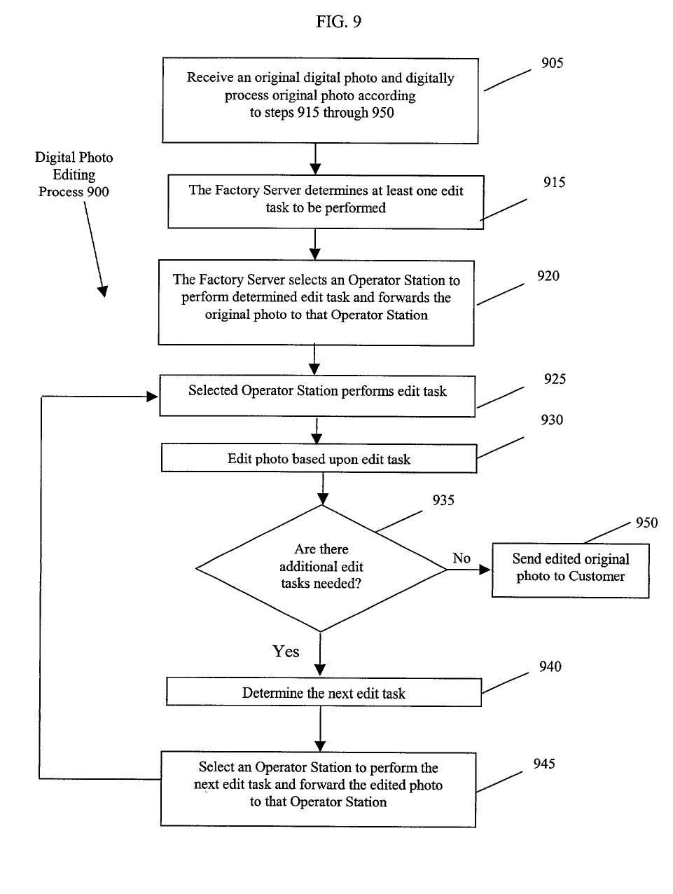

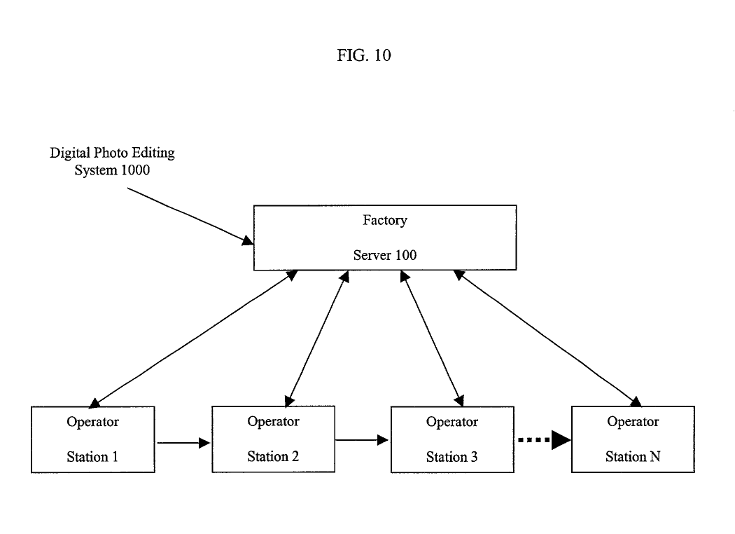

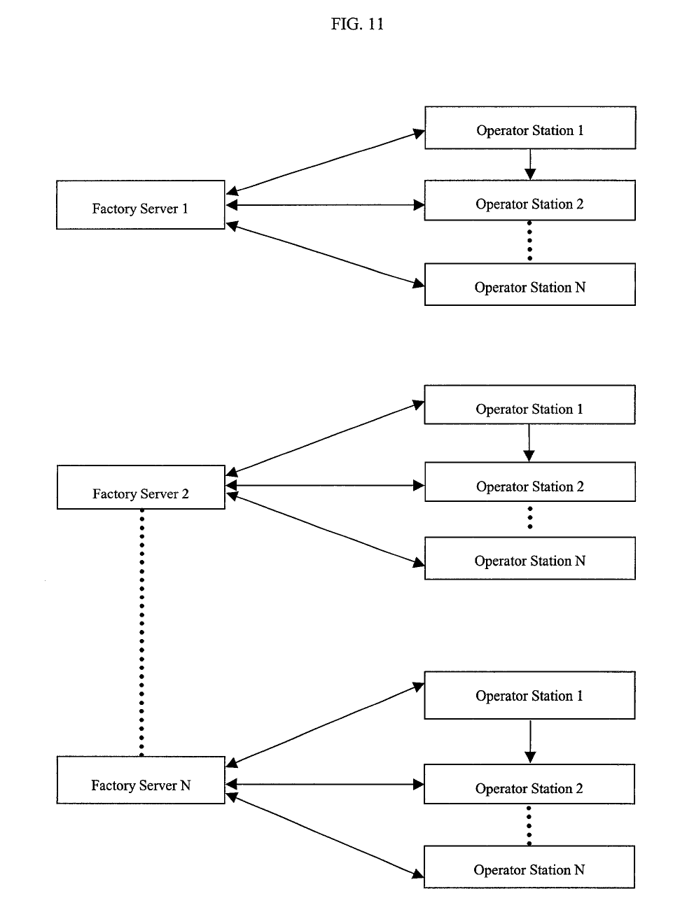

FIG. 1 is a flow diagram illustrating a Digital Photo Editing Process 100, which edits digital photos according to the present invention. This diagram illustrates the major advantages of the present invention, wherein the present invention takes a customer's original photo, creates a proxy photo from that original photo and digitally processes that proxy photo at a remote facility using an assembly line of Operator Stations to generate a photo-editing script, which is used to create an edited photo for the customer. FIGS. 2-8 illustrate various digital photo editing systems that edit digital photos according to a number of embodiments of the present invention, including the preferred embodiment. FIG. 9 illustrates the digital photo editing process steps according to another embodiment of the present invention, wherein an edited photo is generated without creating a photo-editing script. Finally, FIGS. 10 and 11 illustrate two other digital photo editing system designs that can be used to edit photos according to the present invention.

Referring again to FIG. 1, in Step 105, a digital proxy photo is received into a digital photo editing system. The proxy photo is generated from the customer's original photo. Pursuant to step 110, the proxy photo is processed at a remote facility according to steps 115-150 using an assembly line of at least one Operator Station, at least one of which has a human operator. The remote facility can be housed at any desired location, and each Operator Station can perform a portion or all of the tasks required to fully edit a photo. Multiple Operator Stations may perform the same tasks based on system demands. Moreover, each Operator Station generates edit results that may be used to create a photo-editing script.

At step 115, the photo editing system determines at least one edit task to be performed on the proxy photo. This edit task can be one that actually affects the pixels of the proxy photo, e.g., changing the brightness, or the edit task can analyze the proxy photo without changing its pixels and gather information to be used later in the process, e.g., does the photo need to have red-eye removal performed. The digital photo editing system then selects an Operator Station to perform the determined edit task and forwards the proxy photo to that Operator Station, at step 120. The selected Operator Station performs the determined edit task and generates edit results that are stored in a database, at step 125.

The photo editing system then determines if the proxy photo needs additional editing, at step 130. If additional editing is needed, the photo editing system: updates the proxy photo either by editing the pixels or by forwarding the analysis information; determines a next edit task; selects an Operator Station to perform the next edit task; and forwards the proxy photo to the next Operator Station, at steps 135, 140, and 145. The processing loop at steps 125 through 145 is continued until all required editing steps have been performed.

When the proxy photo does not require additional editing, the photo editing system generates a photo-editing script from the edit results of each Operator Station used, at step 150. This photo-editing script contains all of the data needed to generate an edited photo by applying the data contained in the script to the customer's original photo.

In another embodiment of the invention, this digital photo editing system could return an edited digital image to the customer, without the need for a photo-editing script. Such a process would have similar processing steps as illustrated in FIG. 1, with the exception of step 150. At step 150, instead of generating a photo-editing script, the updated proxy photo would be returned to the customer, preferably in a compressed form for maximum efficiency. Moreover, in yet another embodiment, the digital photo editing system could be modified to edit the customer's original photo, instead of a proxy photo. At Steps 105 and 110, the customer's original photo would be received and processed, and a copy of the original photo would be retained so that the photo-editing script could be applied to the retained original photo to generate an edited photo.

FIG. 2 is a block diagram illustrating a digital photo editing System 200 that edits digital photos according to a preferred embodiment of the present invention. System 200 includes a Master Server 10 and a Remote Facility 210. Remote Facility 210 includes Factory Server 20, and an assembly line of Operator Stations one (1) through N, many of which are manned by human operators, which perform the digital photo processing. However, some stations may be “virtual” stations that conduct their part of the process in software only, without human intervention. An example is noise removal. Typically, digital cameras have a “Christmas Lights” noise structure that can be seen by the human eye. This noise looks like red and green dots that overlay the image. Software using a complex algorithm can remove this noise without human intervention.

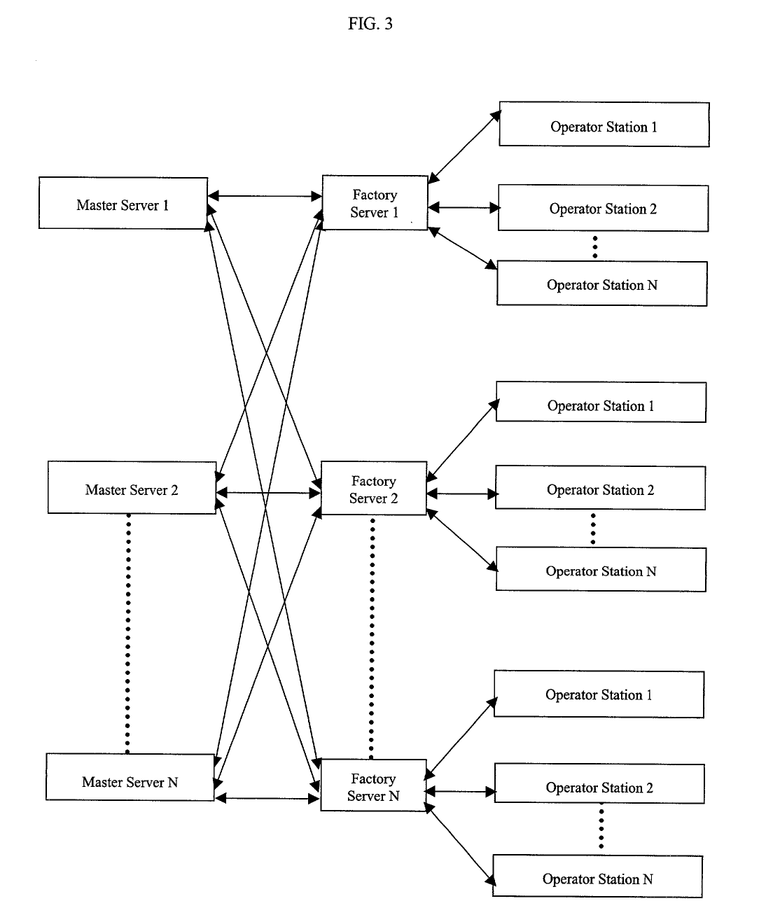

FIG. 2 illustrates a System 200 that includes a single Master Server and a single Factory Server. However, multiple Master Servers and Factory Servers, each with Operator Stations, can be used for purposes of load balancing, as shown in FIG. 3. Load balancing allows each Master Server to select an available remote facility for processing to allow an efficient use of resources.

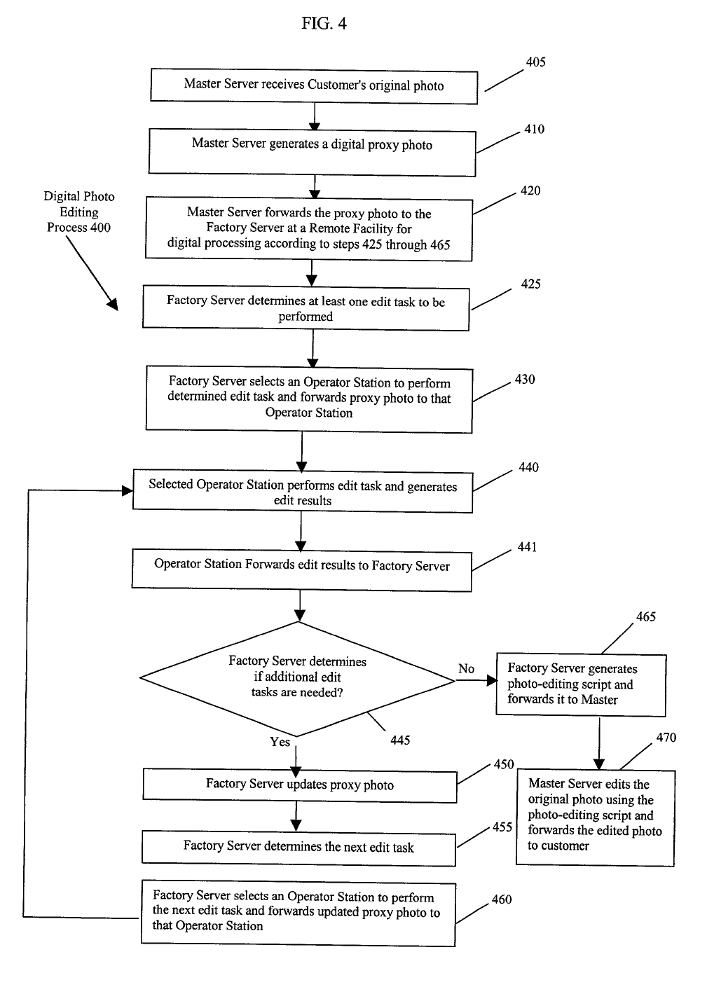

FIG. 4 is a flow diagram illustrating Digital Photo Editing Process 400, which is performed by the system illustrated in FIG. 2 and performed according to a preferred embodiment of the present invention. As illustrated in FIG. 4, the customer sends a job request with an original photo to be edited to the Master Server, at step 405. The customer could include an online photofinisher, a photo-retailer or wholesaler or an individual end-user at home on a PC. The Master Server is preferably a computer, and the customer sends his photo to this server indirectly, e.g., the customer can electronically transmit the original photo, for instance by uploading it to a web site, or the customer can for instance send the original photo to the Master Server through the United States mail in print form, in digital photo media form, e.g. CD-ROM, Compact Flash or Smart Media, or in some other form. The customer might also transmit to the Master Server, either with the initial job request or periodically thereafter, additional information related to editing the original photo. Such information could include desired print size, minimum print resolution, or color management information for the customer's photo printers. Some of this information is file specific, like print size. Other information is customer specific, like color management information. The latter is sent periodically and/or at initialization.

At steps 410 and 420, the Master Server retains a copy of the original photo and creates a proxy photo from the original photo, and in a conventional way, e.g., by transmitting the proxy photo as a data file over the internet, forwards that proxy photo to a Factory Server at a remote facility for processing according to steps 425-465. Customer preference information and other job information is preferrably sent as a separate file to the Factory Server. The present invention also contemplates that multiple proxy photos could be created for a given original photo if multiple edited photos are requested, e.g., photos of different size or where different images in the photo are selected to create separate edited photos.

Proxy photos are created to provide efficient data transmission of the digital photo to the Factory Server. Transmitting proxy photos instead of original photos also enables the Master Server and the Factory Server to be at remote locations to take advantage, for example, of the lower cost of offshore labor markets. The Master Server may use size reducing techniques such as image compression to create the proxy photos so that they are smaller than the original photo. For example, a digital photo taken by a 3 megapixel camera might range from nine megabytes of data for an uncompressed file to 500 to 1,000 kilobytes of data for a compressed file. Preferably, the size of the proxy photo ranges between 50 to 100 kilobytes of data. Additional processing may be applied to the proxy photos to make their visual appearance more similar to the original photos in order to counteract the visual effects of the image compression techniques used to create the proxy photos. This is done so that the human operators at the Operator Stations can more accurately make their editing decisions.

Referring again to FIG. 4, the Factory Server determines at least one edit task to be performed on the proxy photo, at step 425. The Factory Server selects an Operator Station to perform the first determined edit task and forwards the proxy photo to the selected Operator Station, at step 430. The human operator at the selected Operator Station performs the determined edit task on the proxy photo until satisfied with the result for that task and generates edit results, at step 440, wherein another proxy photo is then presented to that human operator for processing. The proxy photo is decompressed as necessary, either by the Factory Server or the selected Operator Station, to facilitate the operator in performing the determined edit task. The proxy photo is then recompressed as needed for efficient transmission back to the Factory Server for further processing after a selected Operator Station performs its edit task.

Once the edit task is completed to the satisfaction of the operator of the selected Operator Station, the Operator Station sends its edit results to the Factory Server at step 441. If the edit results contain analysis information, the Factory Server may transmit this analysis information or a modified version of it to the next Operator Station performing the next edit task if it is determined at step 445 that the proxy photo requires additional editing. However, if the edit results change the pixels of the digital image contained in the proxy photo, the Operator Station preferably sends the Factory Server a script containing those edit results, to be used to generate the photo-editing script.

The Factory Server determines whether the proxy photo requires additional edits, at step 445. If so, the Factory Server updates the proxy photo based upon the edit results, determines the next edit task, selects an Operator Station to perform that edit task and forwards the proxy photo to the selected Operator Station, at steps 450 through 460. Alternatively at step 450, the selected Operator Station could update the proxy photo and forward it to the Factory Server to send to the next Operator Station.

The Factory Server tracks the photo editing job as it proceeds from the first selected Operator Station to the final selected Operator Station, and steps 440 through 460 are repeated for each selected Operator Station until the Factory Server determines that no additional edit tasks are needed. Moreover, since subjective judgments are made at each Operator Station, the Factory Server will preferably send all photos from a given customer's job to the same series of Operator Stations to insure consistency.

The Factory Server sequences edit tasks to achieve optimum results. The Operator Stations preferably perform the following edit tasks in the following order: composition (which includes rotation and cropping), tone adjustment (which includes brightness, contrast and dynamic range), color balance adjustment, sharpness, and refinement (which includes red-eye removal). Refinement is an important final step performed that allows subtler edits like those listed here, but allows them to be done with a brush so that they are applied to local regions. For example, the tone of the photo may be good overall as a result of the previous tone adjustment step, but a subtle brightness adjustment to facial features might be desired. Although the preferred order of steps is listed above, these steps could be reordered. For instance, red-eye removal could fall almost anywhere in the sequence.

In addition, some images may only require that a subset of edit tasks be performed. For example, a landscape image may have no people and thus no eyes from which to remove red-eye. However, all steps are considered for a given image though some may not be performed. In addition, some edited proxy photos may require small adjustments again later in the process as a result of another edit task. For instance, changing the sharpness can modify the perceived brightness. So, the operator who edits a proxy photo's sharpness might be asked to perform a small and simple brightness adjustment to account for this. This brightness adjustment would likely be much simpler than the general tone adjustment performed by that operator.

Once the desired editing tasks have been completed for a given proxy photo, the Factory Server places the collection of edit results from the selected Operator Stations into a photo-editing script and forwards this script in a conventional way, e.g., by transmitting the script as a data file over the internet, to the Master Server, at step 465. This photo-editing script contains all the information needed to recreate the edits made to the proxy photo and generally contains less than 50 kilobytes of data. The Factory Server preferably creates the photo-editing script by combining the smaller scripts received from the selected Operator Stations.

At step 470, the Master Server preferably uses the data contained in the photo-editing script to edit the original photo retained by the Master Server. The edited photo is then sent back to the customer either alone or with any other edited photos in the job, at step 470. The Master Server can electronically transmit the edited photo to the customer, or the customer can receive the edited photo in print form, in digital photo media form, e.g. CD-ROM, Compact Flash or Smart Media, or in some other form.

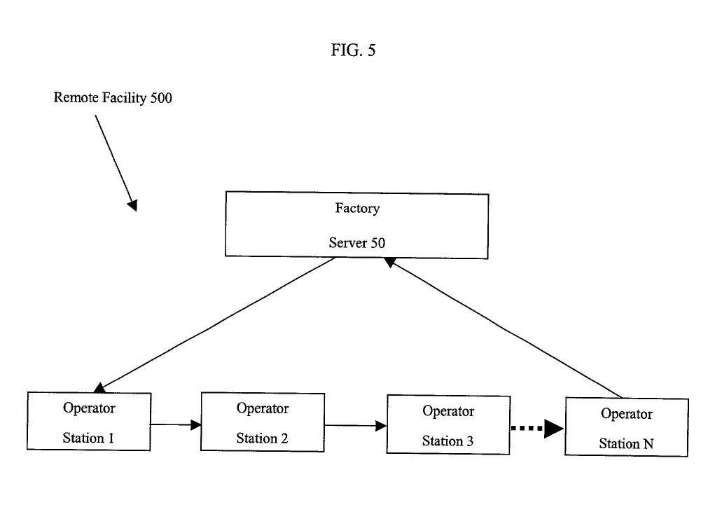

FIG. 5 is a block diagram illustrating the remote facility of a photo editing system that performs the digital processing step according to another embodiment of the present invention. FIG. 5 shows Remote Facility 500, which includes Factory Server 50 and Operator Stations 1 through N. In this embodiment, each Operator Station is equipped to determine the next edit task to be performed on the proxy photo and then to forward the proxy photo to the next Operator Station to perform that determined task.

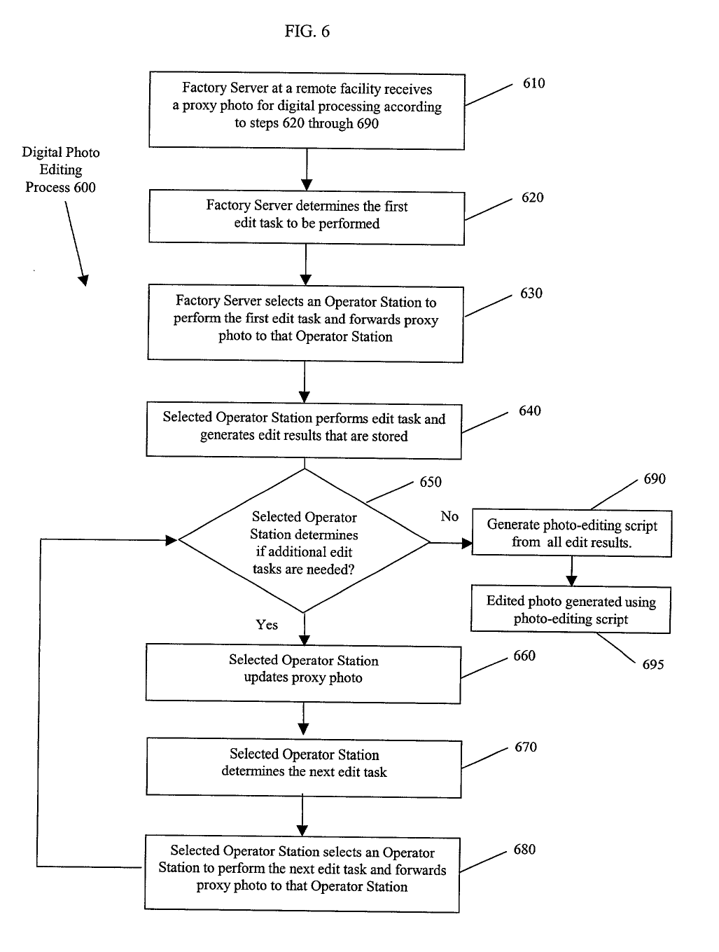

FIG. 6 is a flow diagram illustrating Digital Photo Editing Process 600, which is performed at the remote facility illustrated in FIG. 5. The Factory Server receives the proxy photo at step 610 for digital processing according to steps 620 through 690 using the assembly line of Operator Stations. The proxy photo may have been sent by a Master Server or by the customer directly. The Factory Server determines the first edit task to be performed, at step 620. The Factory Server then selects an Operator Station to perform the first edit task and forwards the proxy photo to that Operator Station at step 630. The selected Operator Station performs the edit task and generates edit results that are stored at Step 640, preferably by being returned to the Factory Server.

If the selected Operator Station determines that the proxy photo needs additional editing, at step 650, the selected Operator Station then updates the proxy photo at step 660. The selected Operator Station then determines the next edit task, selects an Operator Station to perform the next edit task, and forwards the updated proxy photo to the next Operator Station, at steps 670 and 680. Steps 650 through 680 are repeated until a selected Operator Station determines that there are no additional edit tasks needed, at Step 660. Once all of the desired edit tasks have been performed on the proxy photo, a photo-editing script is generated from the edit results of all the selected Operator Stations, at step 690.

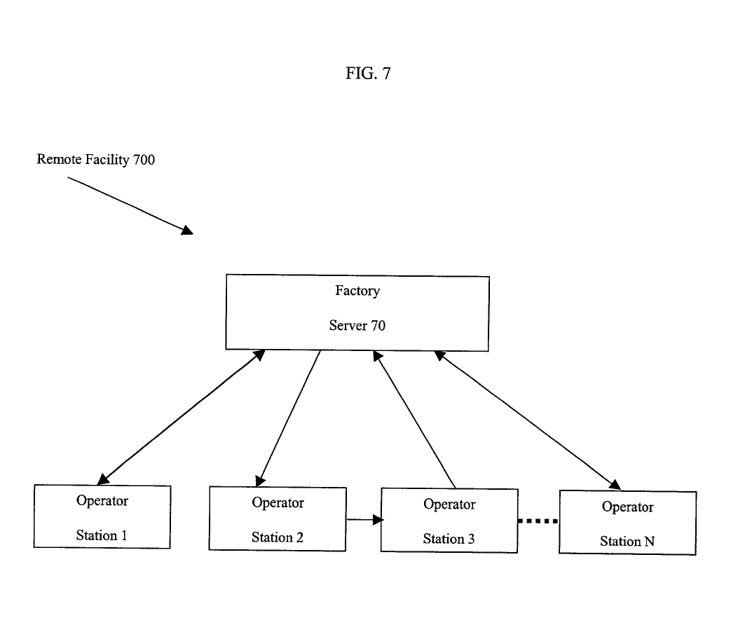

FIG. 7 is a block diagram illustrating a remote facility that performs the digital processing step according to another embodiment of the present invention, wherein the Factory Server or an Operator Station may determine a next edit task to be performed and then either the Factory Server or the Operator Station may forward the proxy photo to the next Operator Station. FIG. 7 shows a Remote Facility 700, which includes Factory Server 70 and an assembly line of Operator Stations 1 through N. In this embodiment, multiple Operator Stations may perform a single editing task. For instance, Operator Station 2 might perform part of an editing task and then forward the proxy photo to Operator Station 3, who completes the editing task and in turn forwards the proxy photo back to Factory Server 70 for continued processing. This might occur with respect to the red-eye removal operations that might be divided between two Operator Stations. The first Operator Station 2 would find the eye, and Operator Station 3 would remove the red. There are a multitude of other variations in the digital photo editing process steps that can be performed at Remote Facility 700.

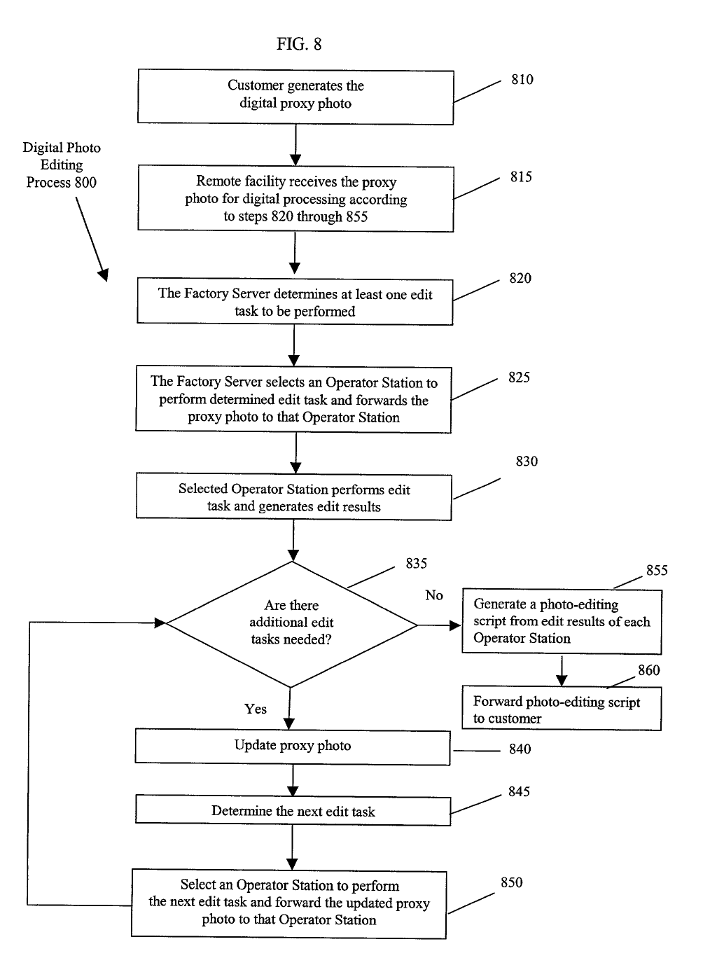

FIG. 8 is a flow diagram illustrating the digital photo editing process steps according to another embodiment of the present invention, wherein the customer generates the digital proxy photo. This embodiment is valuable when the customer's connection to the internet is bandwidth-constrained. The customer generates the digital proxy photo at step 810. The customer then sends the proxy photo to a digital photo editing system which may or may not have a Master Server. At step 815, the Factory Server at the remote facility receives the proxy photo for digital processing, according to steps 820 through 855. The Factory Server determines at least one edit to be performed at step 820. The Factory Server then selects an Operator Station to perform the determined edit task and forwards the proxy photo to that Operator Station, at step 825. The selected Operator Station performs the edit task and generates edit results, at step 830. The photo editing system determines if the proxy photo needs additional editing at step 835.

If additional editing is needed, the photo editing system updates the proxy photo, determines the next edit task, selects an Operator Station to perform the next edit task, and forwards the proxy photo to that Operator Station, at steps 840, 845, and 850. Steps 835 through 850 are repeated until all desired editing tasks have been completed. When there are no further edit tasks needed, the photo editing system generates a photo-editing script from the edit results of the Operator Stations used, at step 855, and either the Factory Server or the Master Server if one was used forwards the photo-editing script to the customer at step 860. The customer would then apply the data contained in the script to the original photo to generate an edited photo. Depending upon the photo editing system used, steps 835 through 855 could be performed by the Factory Server or by various Operator Stations.

FIG. 9 is a flow diagram illustrating the digital photo editing process step according to another embodiment of the present invention, wherein the process edits a customer's original digital photo without generating a photo-editing script. The digital photo editing system used to perform this embodiment receives an original digital photo at step 905 and then digitally processes the original photo, using a Factory Server and an assembly line of Operator Stations according to steps 915 through 950. The Factory Server determines at least one edit task to be performed, at step 915. The Factory Server selects an Operator Station to perform that determined edit task, and forwards the original photo to the selected Operator Station, at step 920. The selected Operator Station performs the edit task at step 925. The edit task may either analyze the original photo for further processing or change the pixels of the original photo. The original photo is then edited at Step 930 based upon the edit task.

If the photo editing system determines at step 935 that the proxy photo needs additional editing, the photo editing system determines the next edit task, selects an Operator Station to perform the next edit task, and forwards the proxy photo to that Operator Station, at steps 940 and 945. Steps 925 through 945 are repeated until all desired editing tasks are completed. When no more editing is required, the photo editing system sends the edited original photo to the customer, at step 950. Depending upon the photo editing system used, steps 930 through 945 can be performed by the Factory Server, or various Operator Stations, and the photo editing system may or may not include a Master Server.

FIGS. 10 and 11 both illustrate digital photo editing systems that edit digital photos according to the present invention, but the systems do not utilize a Master Server. FIG. 10 shows Digital Photo Editing System 1000, which includes a single Factory Server 100 and an assembly line of Operator Stations, one through N, all at a remote facility. FIG. 11 shows a system which uses multiple Factory Servers 1 through N, each of which is connected to a separate assembly line of Operator Stations 1 through N.

The methods for semiautomated digital photo editing described in the text above were chosen as being illustrative of the best mode of the present invention. All embodiments of the present invention described above are illustrative of the principles of the invention and are not intended to limit the invention to the particular embodiments described. Accordingly, while the preferred embodiment of the invention has been illustrated and described, it will be appreciated that various changes can be made therein without departing from the spirit and scope of the invention as claimed.

What is claimed is:

1. A method for digital photo editing comprising the steps of:
(a) receiving a digital proxy photo, said proxy photo being generated from a customer's original photo; and
(b) digitally processing said proxy photo at a remote facility using an assembly line of at least one Operator Station, wherein at least one of said Operator Stations has a human operator, said digital processing comprising the steps of:
(1) determining at least one edit task to be performed on said proxy photo;
(2) selecting one of said Operator Stations to perform one said edit task and forwarding said proxy photo to said selected Operator Station;
(3) performing at said selected Operator Station said edit task and generating edit results;
(4) determining whether any additional edit tasks need to be performed on said proxy photo, and if so, updating said proxy photo to include said edit results generated in step (3) and performing steps (5) and (6);
(5) determining a next edit task to be performed on said updated proxy photo;
(6) selecting one of said Operator Stations to perform said next edit task and forwarding said updated proxy photo to said selected Operator Station, and repeating steps (3) and (4); and
(7) generating a photo-editing script, said photo editing script containing the edit results generated by each said selected Operator Station.

2. The method of claim 1, wherein an edited photo is generated using said photo-editing script.

3. The method of claim 1, wherein said proxy photo is created by said customer.

4. The method of claim 1, wherein each said edit task to be performed on said proxy photo is determined in accordance with a preferred sequence of edit tasks, said preferred sequence of edit tasks comprises:
composition, including rotation and cropping;
tone adjustment, including brightness, contrast, and dynamic range;
color balance adjustment;
sharpness; and
refinement.

5. The method of claim 1 further comprising a step of receiving at least one photo editing instruction, wherein said at least one instruction can be received when said proxy photo is received and periodically during said step (b) of digitally processing said proxy photo.

6. The method of claim 1, wherein each said Operator Station is configured to perform at least one edit task.

7. The method of claim 1, wherein said proxy photo is generated using image compression, and said step (b) of digitally processing said proxy photo further comprises generating a decompressed version of said proxy photo.

8. A method for digital photo editing comprising the steps of:
(a) receiving in a Master Server a customer's original photo;
(b) generating in said Master Server a digital proxy photo, said proxy photo being generated from said original photo;
(c) forwarding said proxy photo to a remote facility, which includes a Factory Server and an assembly line of at least one Operator Station, wherein at least one of said Operator Stations has a human operator;
(d) digitally processing said proxy photo at said remote facility, said digital processing comprising the steps of:
(1) determining by said Factory Server at least one edit task to be performed on said proxy photo;
(2) selecting by said Factory Server one of said Operator Stations to perform said edit task and forwarding said proxy photo to said selected Operator Station;
(3) performing by said selected Operator Station said edit task and generating edit results;
(4) forwarding said edit results by said selected Operator Station to said Factory Server;
(5) determining by said Factory Server whether any additional edit tasks need to be performed on said proxy photo, and if so, updating by said Factory Server said proxy photo to include said edit results generated in step (3) and performing steps (6) and (7);
(6) determining by said Factory Server a next edit task to be performed on said updated proxy photo;
(7) selecting by said Factory Server one of said Operator Stations to perform said next edit task and forwarding said updated proxy photo to said selected Operator Station, and repeating steps (3), (4) and (5); and
(8) generating by said Factory Server a photo-editing script containing the edit results generated by each said selected Operator Station and forwarding said photo-editing script to said Master Server; and
(e) editing by said Master Server said original photo retained by said Master Server according to said photo-editing script and forwarding said edited photo to said customer.

9. The method of claim 8, wherein said proxy photo is generated using image compression and said step (d) of digitally processing said proxy photo further comprises generating a decompressed version of said proxy photo.

10. A method for digital photo editing at a remote facility having a Factory Server and an assembly line of at least one Operator Station, wherein at least one of said Operator Stations has a human operator, comprising the steps of:
(a) receiving a digital proxy photo at said Factory Server, said proxy photo being generated from a customer's original photo;
(b) digitally processing said proxy photo at said remote facility, said digital processing comprising the steps of:
(1) determining by said Factory Server at least one edit task to be performed on said proxy photo;
(2) selecting by said Factory Server one of said Operator Stations to perform said edit task and forwarding said proxy photo to said selected Operator Station;
(3) performing at said selected Operator Station said edit task and generating edit results;
(4) forwarding said edit results by said selected Operator Station to said Factory Server;
(5) determining by said Factory Server whether any additional edit tasks need to be performed on said proxy photo, and if so, updating by said selected Operator Station said proxy photo to include said edit results generated in step (3) and performing steps (6) and (7);
(6) determining by said Factory Server a next edit task to be performed on said updated proxy photo;
(7) selecting by said Factory Server one of said Operator Stations to perform said next edit task and forwarding said updated proxy photo to said selected Operator Station, and repeating steps (3), (4), and (5); and
(8) generating by said Factory Server a photo-editing script containing the edit results generated by each said selected Operator Station; and
(c) generating an edited photo by using said photo-editing script.

11. A method for digital photo editing at a remote facility having a Factory Server and an assembly line of at least one Operator Station, wherein at least one of said Operator Stations has a human operator, comprising the steps of:
(a) receiving a digital proxy photo at said Factory Server, said proxy photo being generated from a customer's original photo; and
(b) digitally processing said proxy photo at said remote facility, said digital processing comprising the steps of:
(1) determining by said Factory Server at least one edit task to be performed on said proxy photo;
(2) selecting by said Factory Server one of said Operator Stations to perform said edit task and forwarding said proxy photo to said selected Operator Station;
(3) performing at said selected Operator Station said edit task and generating edit results;
(4) determining by said selected Operator Station whether any additional edit tasks need to be performed on said proxy photo, and if so, updating by said selected Operator Station said proxy photo to include said edit results generated in step (3) and performing steps (5) and (6);
(5) determining by said selected Operator Station a next edit task to be performed on said updated proxy photo;
(6) selecting by said selected Operator Station, one of said Operator Stations to perform said next edit task and forwarding by said selected Operator Station said updated proxy photo to said Operator Station selected to perform said next edit task, and repeating steps (3) and (4); and
(7) generating a photo-editing script from the edit results generated by each said selected Operator Station; and
(c) generating an edited photo by using said photo-editing script.

12. A method for digital photo editing at a remote facility having a Factory Server and an assembly line of Operator Stations, wherein at least one of said Operator Stations has a human operator, comprising the steps of:
(a) receiving a digital proxy photo at said Factory Server, said proxy photo being generated from a customer's original photo; and
(b) digitally processing said proxy photo at said remote facility, said digital processing comprising the steps of:
(1) determining by said Factory Server at least one edit task to be performed on said proxy photo;
(2) selecting by said Factory Server one of said Operator Stations to perform said edit task and forwarding said proxy photo to said selected Operator Station;
(3) performing at said selected Operator Station said edit task and generating edit results;
(4) determining whether any additional edit tasks need to be performed on said proxy photo, and if so, updating said proxy photo to include said edit results generated in step (3) and performing steps (5) and (6);
(5) determining a next edit task to be performed on said updated proxy photo;
(6) selecting one of said Operator Stations to perform said next edit task and forwarding said updated proxy photo to said Operator Station selected to perform said next edit task, and repeating steps (3) and (4); and
(7) generating a photo-editing script from the edit results generated by each said selected Operator Station; and
(c) generating an edited photo by using said photo-editing script.

13. A method for digital photo editing comprising the steps of:
(a) receiving in one of a plurality of Master Servers a customer's original photo;
(b) generating in said Master Server a digital proxy photo from said customer's original photo;
(c) selecting by said Master Server one of a plurality of remote facilities, each said remote facility including a Factory Server and an assembly line of at least one Operator Station, wherein at least one of said Operator Stations has a human operator, and forwarding by said Master Server said proxy photo to said Factory Server at said selected remote facility;
(d) digitally processing said proxy photo at said selected remote facility, said digital processing comprising the steps of:
(1) determining by said Factory Server at least one edit task to be performed on said proxy photo;
(2) selecting by said Factory Server one of said Operator Stations to perform said edit task and forwarding said proxy photo to said selected Operator Station;
(3) performing by said selected Operator Station said edit task and generating edit results;
(4) determining whether any additional edit tasks need to be performed on said proxy photo, and if so, updating said proxy photo to include said edit results generated in step (3) and performing steps (5) and (6);
(5) determining a next edit task to be performed on said updated proxy photo;
(6) selecting one of said Operator Stations to perform said next edit task and forwarding said updated proxy photo to said selected Operator Station, and repeating steps (3) and (4);
(7) generating a photo-editing script from the edit results generated by each said selected Operator Station; and
(8) forwarding said photo-editing script by said Factory Server to said Master Server that received said customer's original photo; and
(e) generating by said Master Server an edited photo by using said photo-editing script and forwarding said edited photo to said customer.

14. A method for digital photo editing at a remote facility having a Factory Server and an assembly line of at least one Operator Station, wherein at least one of said Operator Stations has a human operator, comprising the steps of:
(a) receiving a digital proxy photo at said Factory Server, said proxy photo being generated from a customer's original photo; and
(b) digitally processing said proxy photo at said remote facility, said digital processing comprising the steps of:
(1) determining by said Factory Server at least one edit task to be performed on said proxy photo;
(2) selecting by said Factory Server one of said Operator Stations to perform said edit task and forwarding said proxy photo to said selected Operator Station;
(3) performing at said selected Operator Station said edit task and generating edit results;
(4) determining whether any additional edit tasks need to be performed on said proxy photo, and if so, updating said proxy photo to include said edit results generated in step (3) and performing steps (5) and (6);
(5) determining a next edit task to be performed on said updated proxy photo;
(6) selecting one of said Operator Stations to perform said next edit task and forwarding said updated proxy photo to said selected Operator Station, and repeating steps (3) and (4); and
(7) generating a photo-editing script from the results generated by each said selected Operator Station; and
(c) generating an edited photo by using said photo-editing script.

15. A method for digital photo editing at one of a plurality of remote facilities, each said remote facility having a Factory Server and an assembly line of at least one Operator Station, wherein at least one of said Operator Stations has a human operator, comprising the steps of:
(a) receiving a digital proxy photo at said Factory Server of one of said remote facilities, said proxy photo being generated from a customer's original photo; and
(b) digitally processing said proxy photo at said remote facility, said digital processing comprising the steps of:
(1) determining by said Factory Server at least one edit task to be performed on said proxy photo;
(2) selecting by said Factory Server one of said Operator Stations to perform said edit task and forwarding said proxy photo to said selected Operator Station;
(3) performing at said selected Operator Station said edit task and generating edit results;
(4) determining whether any additional edit tasks need to be performed on said proxy photo, and if so, updating said proxy photo to include said edit results generated in step (3) and performing steps (5) and (6);
(5) determining a next edit task to be performed on said updated proxy photo;
(6) selecting one of said Operator Stations to perform said next edit task and forwarding said updated proxy photo to said selected Operator Station, and repeating steps (3) and (4); and
(7) generating a photo-editing script from the edit results generated by each said selected Operator Station; and
(c) generating an edited photo by using said photo-editing script.

16. A method for digital photo editing comprising the steps of:
(a) receiving a customer's original photo in digital form; and
(b) digitally processing said photo using an assembly line of at least two Operator Stations, wherein at least one of said Operator Stations has a human operator, said digital processing comprising the steps of:
(1) determining at least one edit task to be performed on said photo;
(2) selecting one of said Operator Stations to perform one said edit task and forwarding said photo to said selected Operator Station;
(3) performing at said selected Operator Station said edit task;
(4) editing said digital photo based upon said edit task;
(5) determining whether any additional edit tasks need to be performed on said edited photo, and if so, determining a next edit task to be performed on said edited photo and performing step (6);
(6) selecting one of said Operator Stations to perform said next edit task and forwarding said updated photo to said selected Operator Station, and repeating steps (3), (4) and (5); and
(c) forwarding said edited digital photo to said customer.

17. A method for digital photo editing comprising the steps of:
(a) receiving a digital proxy photo, said proxy photo being generated from a customer's original photo; and
(b) digitally processing said proxy photo at a remote facility using an assembly line of at least two Operator Stations, wherein at least one of said Operator Stations has a human operator, said digital processing comprising the steps of:
(1) determining at least one edit task to be performed on said proxy photo;
(2) selecting one of said Operator Stations to perform one said edit task and forwarding said proxy photo to said selected Operator Station;
(3) performing at said selected Operator Station said edit task and generating edit results;
(4) determining whether any additional edit tasks need to be performed on said proxy photo, and if so, updating said proxy photo to include said edit results generated in step (3) and performing steps (5) and (6);
(5) determining a next edit task to be performed on said updated proxy photo;
(6) selecting one of said Operator Stations to perform said next edit task and forwarding said updated proxy photo to said selected Operator Station, and repeating steps (3) and (4); and
(7) forwarding said updated proxy photo to said customer once editing tasks are completed.
